(19) United States
(12) Patent Application Publication
(10) Pub. No.: US 2023/0167259 A1
(43) Pub. Date: Jun. 1, 2023

(54) POLYMER FOAM PROCESSING METHODS AND ARTICLES

(71) Applicant: Trexel, Inc., Wilmington, MA (US)

(72) Inventors: Samuel Edward Dix, Newton, NH (US); Levi A. Kishbaugh, Groveland, MA (US)

(73) Assignee: Trexel, Inc., Wilmington, MA (US)

(21) Appl. No.: 17/959,853

(22) Filed: Oct. 4, 2022

Related U.S. Application Data
(60) Provisional application No. 63/252,047, filed on Oct. 4, 2021.

(51) Int. Cl. C08J 9/12; C08J 9/08; B29C 49/00

(52) U.S. Cl. CPC C08J 9/122; C08J 9/08; B29C 49/0005; C08J 2323/06; C08J 2423/12; C08J 2323/12; C08J 2423/06; C08J 2205/042; C08J 2205/044; C08J 2203/02; C08J 2203/04; C08J 2203/06; B29C 49/04

(57) ABSTRACT

Blow molding methods and related blow molded articles are described herein.

### RELATED APPLICATIONS

This application claims priority to U.S. Provisional Application No. 63/252,047 filed Oct. 4, 2021, which is incorporated herein by reference in its entirety.

### FIELD

The present invention relates generally to polymeric foam processing methods and related articles and more particularly to blow molding methods that use different blowing agent types and related blow molded polymeric foam articles.

### BACKGROUND

Polymeric foams include a plurality of voids, also called cells, in a polymer matrix. A number of techniques for processing polymeric material foams utilize an extruder which plasticates polymeric material by the rotation of a screw within a barrel. In general, polymeric foam processes introduce a blowing agent into fluid polymeric material within the extruder. The mixture of blowing agent and polymeric material may be processed (e.g., blow molded) to form the desired polymeric foam article.

In a typical blow molding process, a parison (an essentially cylindrical polymeric sleeve) is extruded and positioned within a mold, while still hot enough to be moldable. Pressurized gas may be introduced into the interior of the parison which causes it to expand against walls of the mold. A variety of articles may be produced using blow molding techniques including bottles, containers, cases, automotive parts, toys and panels.

By replacing solid plastic with voids, polymeric foams use less raw material than solid plastics for a given volume. Thus, raw material savings increase as the density of a foam decreases. However, polymeric foam articles may have certain properties (e.g., such as impact strength, top-load strength) that are inferior to properties of similar articles formed of solid polymeric materials. For example, certain blow molded foam articles cannot be used in certain applications (e.g., bottles, containers, etc.) because property requirements (e.g., impact strength, top-load strength) are not met.

It would be desirable to produce blow molded polymeric foam articles that have sufficiently good properties (e.g., impact strength, top-load strength) that enable them to be used in certain applications (e.g., bottles, containers, etc.).

### SUMMARY OF THE INVENTION

Blow molding methods and related polymeric foam articles are described herein. In one aspect, a method of blow molding a foam article is provided. The method comprises conveying a mixture comprising a first polymeric material and a chemical blowing agent in a downstream direction in a barrel of an extruder, wherein the chemical blowing agent is decomposable to form carbon dioxide and is present in an amount between 0.20 and 3.00 weight percent based on the total weight of the first polymeric material. The method further comprises introducing a physical blowing agent comprising nitrogen into the mixture through a port in the barrel. The nitrogen is present in an amount between 0.02 and 0.30 weight percent based on the total weight of the first polymeric material. The method further comprises conveying a second polymeric material in a downstream direction in a barrel of an extruder. The method additionally comprises co-extruding the mixture and the second polymeric material to form a multi-layer parison in a mold cavity of a blow mold. The method further comprises recovering a multi-layered blow molded foam article from the mold cavity, the article including a foam layer comprising the first polymeric material and at least one solid layer comprising the second polymeric material.

In another aspect, a blow molded foam article is provided. The blow molded foam article comprises a polymeric material. The article has cells with an average aspect ratio of less than or equal to 5, a thickness of less than 2 mm, a void volume percentage of between 2 and 40%, and failure energy of at least 0.9 J per millimeter of thickness, as measured by a standard ASTM D5420 impact resistance test.

Other aspects and features will become apparent from the following detailed description of the invention when considered in conjunction with the accompanying drawings.

### BRIEF DESCRIPTION OF THE DRAWINGS

FIGS. 1A-1B show an embodiment of a polymer foam blow molding system which may be used along with methods described herein;

FIG. 2 shows an exemplary blow molded article, according to certain embodiments;

FIG. 3 presents an SEM micrograph of an exemplary blow molded article, according to certain embodiments;

FIG. 4 presents an SEM micrograph of a blow molded article prepared using talc, according to certain embodiments; and

FIG. 5 presents an SEM micrograph of an exemplary blow molded article, according to certain embodiments.

### DETAILED DESCRIPTION OF THE INVENTION

Blow molding methods used to form polymeric foam articles are described herein. As described further below, the methods may utilize a chemical blowing agent (e.g., decomposable to form carbon dioxide) and a physical blowing agent (e.g., nitrogen or carbon dioxide). The mixture can then be processed in an extruder, formed into a parison and blown in a mold to form a blow molded article. Blow molded articles produced according to these methods may have desirable characteristics including one or more of the following: less elongated cells, small cell sizes, and/or high toughnesses, e.g., relative to foam articles produced using more conventional foam blow molding techniques. Such articles may be useful, for example, as a variety of consumer and industrial goods, such as bottles, packaging components and containers. Advantageously, the methods described herein may reduce or eliminate the need for separate additives (e.g., talc) that act as nucleation sites for blowing agents and may sacrifice certain properties (e.g., toughness) of the resulting article. Articles with the superior mechanical properties achievable by the methods described herein may thus be blown to larger volumes without risking their mechanical integrity. The methods may be utilized with conventional polymer foam processing equipment such as conventional extrusion screws (e.g., screws that do not include a blowing agent wiping section) and extrusion/blow molding die tooling. For example, the methods may be utilized with conventional dies (e.g., dies that do not include specialized die lips) and conventional molds.

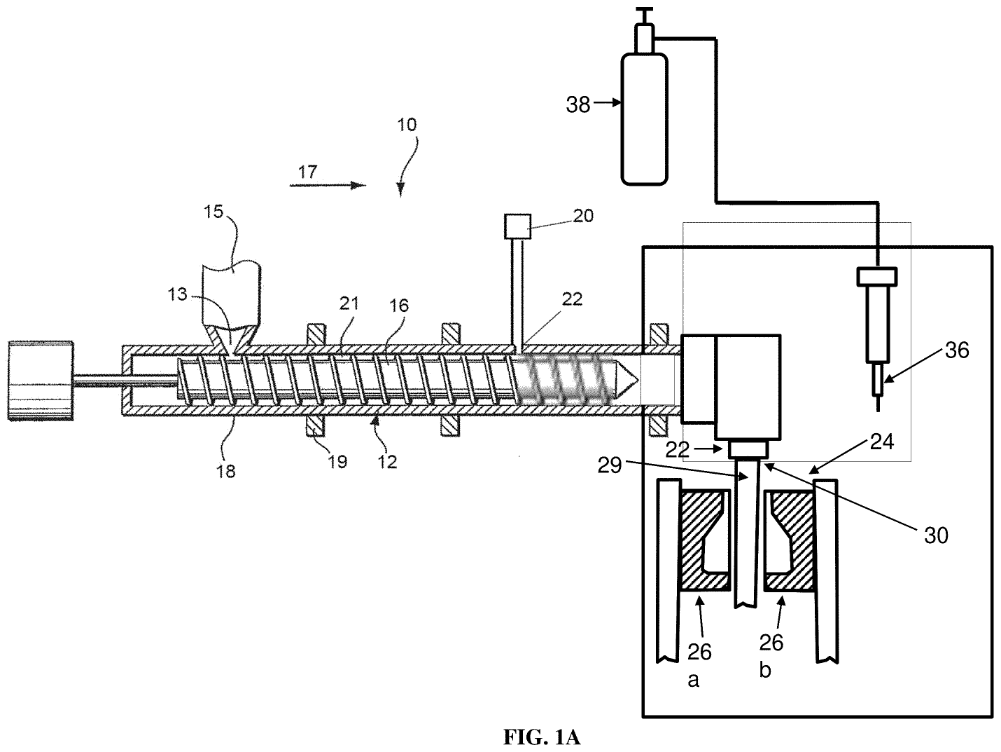

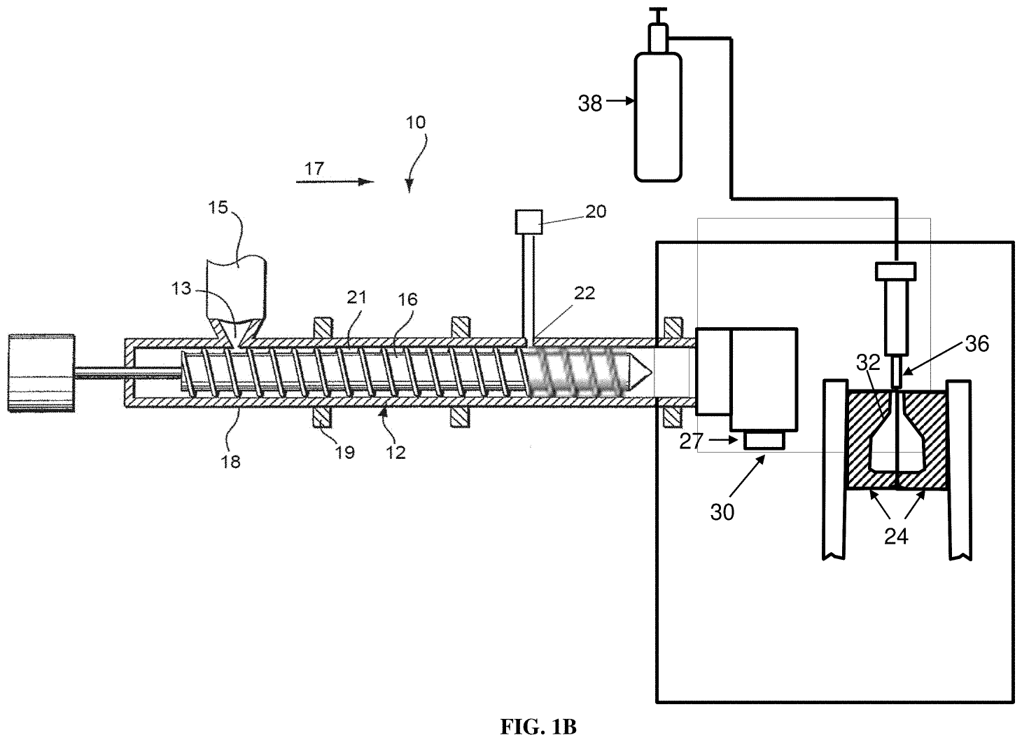

FIGS. 1A-1B illustrate an embodiment of a blow molding system 10 which may be used in methods described herein. In this embodiment, the blow molding system includes an extruder 12 and a mold 14. As shown, a hopper 15 provides polymeric material (e.g., in the form of pellets) to the extruder. The chemical blowing agent (e.g., in the form of pellets, particles, powder, liquid) and other additives (e.g., nucleating agents, fillers, colorants and the like) may also be introduced into the extruder via the hopper or otherwise. The extruder includes a screw 16 designed to rotate within a barrel 18 to process the polymeric material. Heat (e.g., provided by heaters 19 on the extruder barrel) and shear forces (e.g., provided by the rotating screw) act to melt the polymeric material to form a fluid polymeric stream which is conveyed in a downstream direction 17 by rotation of the screw. Such heat and shear forces also cause the chemical blowing agent to react (e.g., by decomposing) to form carbon dioxide which may be present in the fluid stream in the supercritical state within the extruder.

In the illustrated embodiment, a blowing agent introduction system 18 includes a physical blowing agent source 20 that is connected to one or more port(s) 22 in the extruder. Physical blowing agent (e.g., nitrogen or carbon dioxide) is introduced from the source into the fluid stream which becomes a mixture comprising polymeric material and the two types of blowing agent. The mixture may be further mixed as it is conveyed downstream within the extruder. In some embodiments, the mixture is a single-phase solution with the carbon dioxide (from the chemical blowing agent) and nitrogen being dissolved in the polymeric material prior to injection into the mold, though in other embodiments, the mixture may include more than one phase (e.g., polymeric material and undissolved physical blowing agent).

System 10 includes a blow mold 24 having a first mold half 26a and a second mold half 26b which may be opened and closed, for example, by the movement of a press. In a first position (FIG. 1A), blow mold 24 is in an open configuration and is positioned to receive a parison 29 released from an outlet 30 of die 27. The parison may comprise a single polymeric material and may be created using a single extruder; however, in some embodiments, multiple extruders 12 may be used, each conveying a polymeric material downstream to a die that co-extrudes the polymeric materials. For example, a first extruder may convey a mixture as described above, while a second extruder conveys a second polymeric material that may be used to form a solid layer of the parison. After receiving the parison, the blow mold closes to capture the parison in a mold cavity 32 (FIG. 1B) and moves to a position under blow pin 36, thereby separating the parison from the die. The blow pin injects a gas provided by gas supply 38 into the parison. The gas provides an internal pressure (e.g., blow pressure) that forces the parison against the walls of the mold, thereby molding the article. The molded parison is cooled within mold cavity 32 for a sufficient time, after which mold halves 26a, 26b separate to open cavity 32 to produce a blow molded article.

Any of a variety of suitable blow pressures may be used. In some embodiments, the blow pressure is greater than or equal to 20 psi, greater than or equal to 40 psi, greater than or equal to 60 psi, or greater. In some embodiments, the blow pressure is less than or equal to 100 psi, less than or equal to 80 psi, less than or equal to 60 psi, or less. Combinations of these ranges are possible. For example, in some embodiments, blow pressure is greater than or equal to 20 psi and less than or equal to 100 psi. Other ranges are also possible. In some embodiments, it may be advantageous to use a relatively low blow pressure (compared to the blow pressure that would be used to blow mold a comparable, non-foamed article. For example, in some embodiments, a blow pressure of greater than or equal to 20 psi and less than or equal to 60 psi (e.g., a blow pressure of approximately 40 psi) is used. A comparable non-foamed article might be blown with a blow pressure of 80 to 100 psi.

In the illustrated embodiment of FIG. 1B, a valve is arranged between the outlet of the extruder and the inlet of the mold. The mixture (e.g., single-phase solution) may be accumulated downstream of the screw within the extruder causing the screw to retract in an upstream direction within the barrel. At a suitable time, the screw stops retracting and rotating, and may be forced downstream to inject the mixture into mold cavity 32 of the mold when the valve opens. The mixture is subjected to a pressure drop during injection which nucleates a large number of cells and a polymer foam article is formed in the mold. The screw begins to rotate once again and the method is typically repeated to produce additional foam articles.

It should be understood that polymer foam processing system may include a number of conventional components not illustrated in the figure. For example, the system may include a control system which contributes to controlling the operation of different components such as the operation of the blowing agent metering system, rotation and movement of the screw, as well as the opening and closing of valves, amongst other operations.

In general, methods described herein may utilize any suitable chemical blowing agent. For example, methods described herein may utilize a chemical blowing agent capable of producing carbon dioxide or nitrogen under conditions in the extruder. In some embodiments, chemical blowing agents for producing carbon dioxide are used, which may be advantageous due to their better environmental friendliness. In some embodiments, chemical blowing agents for producing nitrogen are used. Nitrogen producing blowing agents may be less environmentally friendly, but may produce a higher gas volume per gram of blowing agent, and may be used for this reason. The chemical blowing agent may undergo a reaction (e.g., a decomposition reaction) to form carbon dioxide upon being heated in the extruder. Suitable chemical blowing agents may include acids and/or alkalis. In some embodiments, suitable chemical blowing agent may comprise citric acid, sodium bicarbonate, monosodium citrate, dinitroso pentamethylenetetramine (DPT), oxybis (benzenesulfonyl hydrazide) (OBSH), p-toluenesulfonyl hydrazide (TSH), p-toluenesulfonyl semicarbazide (TSS) and calcium carbonate. It should be understood that the reactions that produce carbon dioxide may also produce other by-products which may be detectable in the final molded article. Embodiments of chemical blowing agents capable of producing carbon dioxide may be preferred in some embodiments. However, in other embodiments, methods described herein may utilize a chemical blowing agent capable of producing another inert gas, such as nitrogen, under conditions in the extruder.

As described herein, the inventors have appreciated that using certain amounts of chemical blowing agent (e.g., in combination with certain amounts of physical blowing agent) may be preferred to form blow molded articles having desirable characteristics. For example, it may be preferred for the weight percentage of chemical blowing agent to be between about 0.20 and 3.00 weight percent based on the total weight of the polymeric material. In some of these embodiments, the weight percentage of the chemical blowing agent may be greater than or equal to 0.2 weight percent, may be greater than or equal to 0.3 weight percent, may be greater than or equal to 0.35 weight percent or greater than or equal 0.50 weight percent based on the total weight of the polymeric material; and, in some embodiments, the weight percentage may be less than or equal to 2.0 weight percent, less than or equal to 1.5 weight percent, less than or equal to 1.3 weight percent, or less than or equal to 0.5 weight percent. It should be understood that any suitable ranges defined by the above-noted minimum and maximum values may be used (e.g., between 0.30 weight percent and 2.00 weight percent; between 0.50 weight percent and 1.5 weight percent; between 0.3 weight percent and 1.3 weight percent, etc.).

The chemical blowing agents used in the methods described herein may have any suitable form. In some cases, the chemical blowing agents may be in the form of pellets. In some cases, the chemical blowing agents may be in the form of particles. Other forms may also be also suitable such as flakes, powder or liquid. It should also be understood that the pellets and/or particles (or other forms) may include other components (e.g., non-reactive components) in addition to the chemical blowing agent. In some cases, the particles may have small particle sizes such as less than or equal to 10 microns, less than or equal to 5 microns, less than or equal to 3 microns, and/or less than 1 micron. For example, some such chemical blowing agent particles have been described in U.S. Pat. No. 8,563,621 which is incorporated herein by reference in its entirety.

In general, the chemical blowing agents may be introduced into the polymeric material in the extruder in any suitable manner. As described above, in some embodiments, chemical blowing agents may be introduced into the extruder via the hopper. That is, the chemical blowing agent (e.g., in the form of pellets and/or particles) may be added to the hopper along with the polymeric material (e.g., in the of pellets) and other additives. It should be understood that the chemical blowing agents may also be introduced into the extruder downstream of the polymeric material (e.g., through another port in the barrel or otherwise).

As noted above, the methods described herein may utilize a blowing introduction system to introduce physical blowing agent into the polymeric material. The physical blowing agent may be an inert gas, in some embodiments. For example, the physical blowing agent may comprise nitrogen, carbon dioxide, and/or noble gasses such as argon. In some embodiments, the physical blowing agent is nitrogen. In some embodiments, the blowing agent introduction system may include a metering device (or system) between the physical blowing agent source and the port(s). The metering device can be used to meter the nitrogen so as to control the amount of the nitrogen in the mixture within the extruder to maintain a level of nitrogen at a particular level. For example, the device meters the mass flow rate of the physical blowing agent. As described herein, the inventors have appreciated that using certain amounts of nitrogen physical blowing agent (e.g., in combination with certain amounts of chemical blowing agent) may be preferred to form blow molded articles having desirable characteristics such as small cell sizes, high elongations and relatively high void volumes. For example, it may be preferred for the weight percentage of nitrogen physical blowing agent to be between about 0.02 and 0.3 weight percent based on the total weight of polymeric material. In some of these embodiments, the weight percentage of nitrogen may be greater than or equal to 0.02, greater than or equal to 0.025, greater than or equal to 0.03 greater than or equal to 0.05, or greater than or equal to 0.1 weight percent, based on the total weight of polymeric material. In some embodiments, the weight percentage may be less than or equal to 0.3 weight percent, the weight percentage may be less than or equal to 0.25 weight percent, less than or equal to 0.2 weight percent, less than or equal to 0.15 weight percent, less than or equal to 0.13 weight percent, or less, based on the total weight of polymeric material. It should be understood that any suitable ranges defined by the above-noted minimum and maximum values may be used (e.g., between 0.02 weight percent and 0.3 weight percent; between 0.02 weight percent and 0.3 weight percent, etc.).

In some embodiments, the physical blowing agent is introduced discontinuously into the polymeric material. That is, physical blowing agent introduction into the polymeric material in the extruder may be stopped during a portion of the process. For example, it may be advantageous for the blowing agent flow to be stopped during at least a portion (and, in some cases, substantially all) of the time when the screw ceases to rotate and convey polymeric material in a downstream direction such as when polymeric material and blowing agent mixture is being injected into the mold. It should be understood that various techniques may be used to provide discontinuous blowing agent introduction. Suitable techniques, for example, have been described in U.S. Pat. Nos. 9,180,350; 8,137,600; 6,926,507; 6,616,434; and 6,602,063, each of which is incorporated herein by reference in its entirety.

As noted above, physical blowing agent may be introduced through one or more ports 22. In some embodiments, a single port is provided. In other embodiments, multiple ports may be provided. When multiple ports are present, the ports may be arranged at substantially the same axial position around the extruder barrel but at different radial positions; or, the ports may be arranged at different axial positions (e.g., one port is downstream the other port) along the extruder barrel.

In some embodiments, a blowing agent injector assembly may be positioned within the port(s). The injector assembly may include a plurality of small orifices through which physical blowing agent flows on its pathway into the polymeric material.

The blowing agent introduction system may include a valve (e.g., shut-off valve) arranged proximate to or at the port. In some embodiments, the valve may be a component of the blowing agent injector assembly. The valve may be opened to permit blowing agent to flow therepast (e.g., from the source into the polymeric material in the extruder) and closed to prevent blowing agent from flowing therepast (e.g., from the source into the polymeric material in the extruder).

As noted above, the extruder includes screw 16 designed to rotate within the barrel. Advantageously, the methods described herein do not require introducing blowing agent in the vicinity of a screw that includes a special section (e.g., wiping section) for receiving blowing agent. In general, the methods and systems may utilize a standard screw design. This may, advantageously, eliminate the need for specialized screw designs that are configured to receive blowing agent. For example, screw designs, such as smooth bore or groove feed screws may also be used, and the disclosure is not so limited.

Other conventional components known to those of ordinary skill in the art may be incorporated into the systems described herein, and the disclosure is not thus limited.

Any polymeric material suitable for forming polymeric foams may be used with the methods described herein. Such polymeric materials, in some cases, are or comprise thermoplastics which may be amorphous, semicrystalline, or crystalline materials. In some embodiments, semicrystalline or crystalline materials are preferred. Polymeric materials may comprise polyolefins (e.g., polyethylene and polypropylene), styrenic polymers (e.g., polystyrene, ABS), fluoropolymers, polyamides, polyimides, polyesters, and/or copolymers or mixtures of such polymeric materials. In some embodiments, polyolefin materials may be used. For example, the polymeric material may be polyethylene. As another example, the polymeric material may be polypropylene. In some such embodiments, the polyolefin material may be a mixture of more than one type of olefin, or a mixture of one or more types of polyolefin and one or more types of non-polyolefin polymeric materials. The polymeric material used may depend upon the application in which the article is ultimately utilized.

The polymeric material may have a grade, or may be comprised of a mixture of polymers of different grades. For example, the polymeric material may be or comprise virgin polymer, in some embodiments. In some embodiments, the polymeric material is or comprises recycled polymer. For example, the polymeric material may comprise post-consumer regrind. The post-consumer regrind may comprise mechanical regrind (i.e., a mixture of regrind flakes), mechanically modified regrind (i.e., regrind flakes mixed or agitated with stabilizing additives in a blend), or chemically modified regrind (i.e., regrind flakes that have been reprocessed by melting together with stabilizing additives). In some embodiments, the polymeric material comprises greater than or equal to 0%, greater than or equal to 5%, greater than or equal to 50%, or more recycled material. In some embodiments, the polymeric material comprises less than or equal to 100%, or less than or 75%, or less recycled material. Combinations of these ranges are also possible. For example, the polymeric material may comprise greater than or equal to 0% and less than or equal to 100% recycled material. In some embodiments, virgin material is preferred for its improved mechanical properties. In some embodiments, recycled material is preferred for its reduced cost and waste. One advantage of the systems and methods described herein is that they may be compatible with the use of recycled grades of polymeric materials.

In some embodiments, polymeric materials may be combined with additives other than blowing agents. For example, in some embodiments, polymeric materials are combined with nucleating agents (e.g., talc), fillers, and/or colorants. In some embodiments, methods described herein may advantageously mitigate the need for combining additives with polymeric materials. For example, according to certain embodiments, using multiple blowing agents as described herein may reduce the need for nucleating agents. In certain embodiments, mixtures described herein do not contain nucleating agents. For example, mixtures described herein, in some embodiments, do not contain talc. The exclusion of talc may, advantageously, reduce cell size and/or cell aspect ratio and may increase toughness within blow molded foam articles (e.g., blow molded articles that are free of talc).

In general, the polymeric foam articles have a certain cell size. In some embodiments, the methods described herein may be used to produce foam articles having a small cell size. For example, in some cases, the methods involve production of microcellular foam articles. The microcellular foam article may have an average cell size of less than 100 microns. In some cases, the microcellular foam articles have an average cell size of less than 75 microns. Average cell size may be determined by measuring a representative number of cells using microscopy (e.g., SEM) techniques. In some embodiments (including embodiments involving production of microcellular foam material), the cell size may vary across the thickness of the injection molded article. For example, the cell size at or near the center of the article may be larger than the cell size approaching edges of the article and/or edges of the foamed region of the article.

The blow molded polymeric foam articles may have a range of void volume percentages. As used herein, the void volume percentage is the percentage of the volume of an article occupied by voids. It can be measured by the following equation:

Void volume %=100×[1−(density of the polymer foam article/density of solid polymer)]

For example, if the foam article has a density of 0.85 g/cm³ and the solid polymer has a density of 1.0 g/cm³, then the percentage void volume is 15%. The particular void volume may depend upon the application. In some embodiments, the void volume percentage is relatively low. For example, the void volume percentage may be less than 40%, less than 30, less than 25%, less than 20%, less than 15%, less than 12%, less than 10% or less than 5%. In some embodiments, the void volume may be greater than 2%; greater than 5%, greater than 8%, greater than 10% or greater than 15%. It should be understood that any suitable ranges defined by the above-noted minimum and maximum values may be used (e.g., between 2% and 20%, between 5% and 20%, between 8% and 15%, etc.).

In general, the blow molded polymeric foam articles may have any suitable thickness. As used herein, thickness refers to the predominant cross-sectional dimension across the thickness of the article. For example, the article thickness may be less than 5.0 mm, less than 3.0 mm, less than 2.5 mm, less than 2.0 mm or less than 1.0 mm. In some embodiments, the article thickness may be greater than 0.5 mm, greater than 1.0 mm or greater than 1.5 mm. It should be understood that any suitable ranges defined by the above-noted minimum and maximum values may be used (e.g., between 0.5 mm and 5 mm, between 0.5 mm and 3.0 mm, between 1.0 mm and 3.0 mm, etc.).

Articles blow molded using a physical blowing agent and a chemical blowing agent, without a nucleating agent such as talc, may have densities and thickness that evolve during and/or after blow-molding. Without wishing to be bound by any particular theory, it is believed that continued dissolution of carbon dioxide from the polymer can increase cell volume, thereby increasing thickness of the blow molded article while reducing its density. This effect may be particularly pronounced for a portion of the article that is formed far from a blow pin (e.g., for a portion of the article formed opposite blow pin 36 of FIG. 1B). In contrast, articles blow molded using a nucleating agent may have a foam structure that is less able (e.g., that is totally unable) to expand after injection, resulting in a thinner, denser foam structure. Without wishing to be bound by any particular theory, the increased thickness brought about by continued evolution of the foam of the article may result in significantly improved mechanical properties, as a result of the increased layer thickness. This principle may be particularly advantageous in the context of blow-molded containers (e.g., bottles), where the bottom of the container is typically formed opposite the blow-pin and is the most likely part of the bottle to break as a result of mechanical stress. Thus, the exclusion of nucleating agents such as talc may be particularly advantageous in preparing blow-molded containers—and especially in preparing blow-molded containers with a high interior volume, which are at a greater risk of breakage (relative to low interior volume containers), when filled and subjected to mechanical stress. As described above, in some embodiments, the blow molded polymeric foam articles may have unfoamed skin region(s) extending from the exterior surfaces of the article (e.g., article surfaces that are in contact with the mold). The skin regions may surround (at least in part) a foamed interior region. The total skin thickness and/or percentage of total skin thickness compared to total wall thickness may be characterized using visual techniques (e.g., by eye and/or microscopy). The total skin thickness is the sum of the skin thicknesses across the cross-sectional thickness of the article. It should be understood that an exterior surface may refer to a surface of an exterior of an article, or to a surface of a hollow interior of an article, and the disclosure is not thus limited.

In some embodiments, the total skin thickness may be greater than 100 microns, greater than 200 microns, greater than 250 microns, or greater than 300 microns. In some embodiments, the total skin thickness may be less than 500 microns, less than 400 microns, less than 300 microns, or less than 200 microns. It should be understood that any suitable ranges defined by the above-noted minimum and maximum values may be used (e.g., between 100 microns and 500 microns, between 100 microns and 300 microns, etc.).

It should be understood that not all blow molded articles described herein have an identifiable skin. That is, such articles may comprise substantially entirely of a foamed structure.

An article may be blow molded into any of a variety of suitable forms, including containers (e.g., bottles), cases, automotive parts, toys and panels. In some embodiments, blow molded articles described herein may used to blow mold containers. In particular, as discussed briefly above, a container (e.g., a bottle) with a large volume may be blow molded by a technique described herein. Without wishing to be bound by any particular theory, the superior mechanical properties of articles described herein mean that a blow molded container can hold a large volume without incurring a significant risk of breakage. In some embodiments, a blow molded container has an interior volume of greater than or equal to 0.5 L, greater than or equal to 0.75 L, greater than or equal to 1 L, greater than or equal to 1.25 L, greater than or equal to 1.5 L, greater than or equal to 1.75, or greater. In some embodiments, a blow molded container has an interior volume of less than or equal to 3 L, less than or equal to 2 L, less than or equal to 1.75 L, less than or equal to 1.5 L, or less. Combinations of these ranges are possible. For example, in some embodiments, a blow molded container has an interior volume of greater than or equal to 0.5 L and less than or equal to 2 L. Other ranges are also possible.

The improved mechanical properties of the article may provide other advantages in the preparation of containers. For example, in some embodiments, it may be desirable for a container to interlock with a lid (e.g., by using a screw-top lid). Articles formed with inferior mechanical properties can be damaged by the lid without reinforcement of the article at the site of the lid interlock. In contrast, a foamed article described herein may include an interlocking feature (e.g., a threading for a screw-top lid) without significant risk of breakage when the lid is used.

The blow molded article herein may be a multilayered article. For example, the multiple layers may be formed and combined in a co-extrusion process. For example, a multi-layered parison may be formed as described above, and may be used for blow-molding a multi-layered article. In some embodiments, the blow molded article comprises a foamed layer and at least one (e.g., multiple) solid layer(s). In some embodiments the blow molded article comprises one, two, three, four, five, or more layers. According to certain embodiments, for example, the blow molded article comprises three layers. A tri-layered, blow molded article may comprise a first, solid layer, a second, foamed layer, and a third, solid layer. Layers of a multilayered article may be formed from the same material. For example, a first layer of a multilayered article may comprise a first polymeric material that is solid, and a second layer of the multilayered article may comprise the first polymeric material in a foamed state. However, layers of a multilayered article are formed from different materials, in some embodiments. For example, the first layer of the multilayered article may be formed from a first polymeric material (e.g., polyethylene), and the second layer of the multilayered article may be formed from a second polymeric material (e.g., polypropylene), in some embodiments. According to certain embodiments, the multilayered article may be formed from layers having different grades of the same polymeric material. For example, in some embodiments, the first layer of the multi-layered article comprises a solid, virgin first polymeric material, whereas the second layer of the multi-layered article comprises a foamed, recycled first polymeric material.

In some embodiments, a multi-layered blow molded article comprises a foamed layer with a thickness of greater than or equal to 50%, greater than or equal to 60%, greater than or equal to 70%, or more of the overall thickness of the article. In some embodiments, the multi-layered blow molded article comprises a foamed layer with a thickness of less than or equal to 90%, less than or equal to 80%, less than or equal to 75%, or less of the overall thickness of the article. Combinations of these ranges are possible. For example, in some embodiments, the multi-layered blow molded article comprises a foamed layer with a thickness of greater than or equal to 50% and less than or equal to 90% of the overall thickness of the article. As another example, in some embodiments, the multi-layered blow molded article comprises a foamed layer with a thickness of greater than or equal to 60% and less than or equal to 75% of the overall thickness of the article.

In some embodiments, a multi-layered blow molded article comprises a foamed layer with a void volume percentage of greater than or equal to 5%, greater than or equal to 10%, greater than or equal to 15%, greater than or equal to 20%, or more. In some embodiments, the multi-layered blow molded article comprises a foamed layer with a void volume percentage of less than or equal to 65%, less than or equal to 40%, less than or equal to 25%, less than or equal to 20%, or less. Combinations of these ranges are possible. For example, in some embodiments, the multi-layered blow molded article comprises a foamed layer with a void volume percentage of greater than or equal to 5% and less than or equal to 65%. As another example, in some embodiments, the multi-layered blow molded article comprises a foamed layer with a void volume percentage of greater than or equal to 10% and less than or equal to 25%.

In some embodiments a multi-layered blow molded article comprises one or more solid layer(s) (e.g., two solid layers on either side of a foam layer) with an individual and/or a combined thickness of greater than or equal to 1%, greater than or equal to 2%, greater than or equal to 5%, greater than or equal to 10%, greater than or equal to 20%, or more of the overall thickness of the article. In some embodiments, the multi-layered blow molded article comprises one or more solid layer(s) (e.g., two solid layers on either side of a foam layer) with an individual and/or a combined thickness of less than or equal to 40%, less than or equal to 30%, less than or equal to 20%, less than or equal to 10%, less than or equal to 5%, or less of the overall thickness of the article. Combinations of these ranges are possible. For example, in some embodiments, the multi-layered blow molded article comprises one or more solid layer(s) with an individual and/or a combined thickness of greater than or equal to 1% and less than or equal to 40% of the overall thickness of the article. In some embodiments, the multi-layered blow molded article comprises one or more solid layer(s) with an individual and/or a combined thickness of greater than or equal to 5% and less than or equal to 30% of the overall thickness of the article. As a more specific example, in some embodiments, the multi-layered blow molded article comprises one or more solid layer(s) with an individual and/or a combined thickness of greater than or equal to 5% and less than or equal to 20% of the overall thickness of the article. In cases where two solid layers are present, the two layers may, for example, have substantially the same thickness (e.g., thicknesses within 10% of each other).

The blow molded articles described herein can exhibit excellent properties including excellent mechanical properties such as high elongations. For example, the percent elongation at break (as measured by ASTM D638) may be greater than 5%, greater than 25%, greater than 35%, or greater. In some embodiments, the percent elongation at break (as measured by ASTM D638) may be less than 45%, less than 35%, less than 25% or less. It should be understood that any suitable ranges defined by the above-noted minimum and maximum values may be used (e.g., between 5% and 35%, between 25% and 45%, etc.).

In some embodiments, blow molded articles described herein can exhibit relatively high toughness, compared to foamed plastic articles produced by other means. One method of indirectly evaluating toughness is to measure failure of a flat sheet cut from the article (e.g., using an ASTM D5420 impact resistance test as described with reference to the examples below). The failure energy may be divided by thickness of the article, to produce a normalized measurement. In some embodiments, blow molded articles described herein have a failure energy of at least 0.5 J per millimeter of thickness, 0.7 J per millimeter of thickness, 0.9 J per millimeter of thickness, 1.3 J per millimeter of thickness, or more, as measured by a standard ASTM D5420 impact resistance test. In some embodiments, blow molded articles described herein have a failure energy of less than 7 J per millimeter of thickness, 5 J per millimeter of thickness, 3 J per millimeter of thickness, 1.5 J per millimeter of thickness, or less, as measured by a standard ASTM D5420 impact resistance test. It should be understood that any suitable ranges defined by the above-noted minimum and maximum values may be used (e.g., between 0.5 J per millimeter of thickness and 1.5 J per millimeter of thickness, between 0.9 J per millimeter of thickness and 3 J per millimeter of thickness, etc.).

It should, of course, be understood that an article of any volume may be associated with any of the aforementioned mechanical properties, and that the ranges of mechanical properties described above may be combined with any of the container volumes described above. For example, in some embodiments, an article is a blow molded container having an interior volume of greater than or equal to 0.5 L and less than or equal to 2 L, and an ASTM D5420 impact resistance of between 0.5 J per millimeter and 7 J per millimeter.

In some embodiments, the foam article has an average minimum cell dimension of greater than or equal to 25 microns, greater than or equal to 50 microns, or greater. In some embodiments, the foam article has an average minimum cell dimension of less than or equal to 150 microns, less than or equal to 100 microns, less than or equal to 75 microns, less than or equal to 50 microns, or less. Combinations of these ranges are possible. For example, in some embodiments, foam article has an average minimum cell dimension of greater than or equal to 25 microns and less than or equal to 150 microns.

In some embodiments, the foam article has an average maximum cell dimension of greater than or equal to 100 microns, greater than or equal to 150 microns, or greater. In some embodiments, the foam article has an average maximum cell dimension of less than or equal to 300 microns, less than or equal to 250 microns, less than or equal to 200 microns, less than or equal to 150 microns, less than or equal to 100 microns, or less. Combinations of these ranges are possible. For example, in some embodiments, the foam article has an average maximum cell dimension of greater than or equal to 100 microns and less than or equal to 300 microns. As another example, in some embodiments, the foam article has an average maximum cell dimension of greater than or equal to 100 microns and less than or equal to 200 microns.

In some embodiments, cells of the foam article have an average aspect ratio of greater than or equal to 1.2, greater than or equal to 1.5, or greater. In some embodiments, cells of the foam article have an average aspect ratio of less than or equal to 5, less than or equal to 4, less than or equal to 3.5, less than or equal to 3, less than or equal to 2.5, or less. Combinations of these ranges are possible. For example, in some embodiments, cells of the foam article have an average aspect ratio of greater than or equal to 1.2 and less than or equal to 5. The desirable properties and characteristics enable the blow molded foam articles described herein to be used in a variety of applications. In particular, the articles may be used in a variety of consumer and industrial goods including automotive components and packaging.

The function and advantage of these and other embodiments of the present invention will be more fully understood from the examples below. The following example is intended to illustrate the benefits of the present invention, but does not exemplify the full scope of the invention and should not be considered limiting in this regard.

### Example 1

This example describes preparation of a collection of exemplary blow molded plastic articles prepared using exemplary systems and methods described herein. In these examples, the exemplary blow molded articles were plastic bottles with various geometries, described below. Exemplary embodiments were prepared using a chemical blowing agent (CBA) and nitrogen (N₂) gas. Comparative examples of plastic articles prepared using talc additives, or prepared in the form of solid, substantially nonporous plastic are also provided. Generally, samples were prepared according to the methods described above.

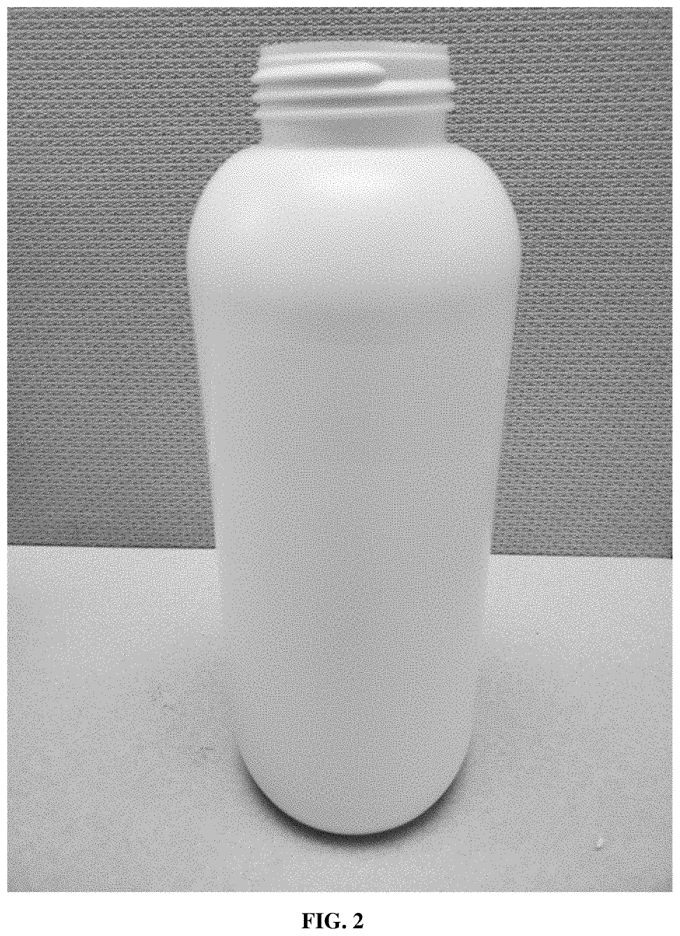

Table 1 present exemplary additives and resins (high density polyethylene, HDPE; or polypropylene, PP) used to produce the exemplary plastic articles, as well as the resulting density of the plastic articles. In these experiments, the plastic articles had the shape of a round bottle with an internal volume of 1 L, as presented in FIG. 2. Note that exemplary articles prepared using nitrogen (N₂) and using chemical blowing agent (CBA) and air are indicated by an asterisk (*) next to their sample number, to distinguish them from comparative examples.

TABLE 1
Physical properties of exemplary articles.

| | | | N₂ | X | Y | Aspect | Density |
|---|---|---|---|---|---|---|---|
| Sample | Resin | Additive (wt %) | (wt %) | (microns) | (microns) | Ratio | (g/cm³) |
| 1 | HDPE | 9% Talc | 0.06 | 375 | 75 | 5:1 | 0.84 |
| 2 | HDPE | 9% Talc | 0.06 | 350 | 50 | 7:1 | 0.88 |
| 3 | HDPE | 9% Talc | 0.10 | 250 | 50 | 5:1 | 0.69 |
| 4* | HDPE | 1% CBA | 0.10 | 200 | 50 | 4:1 | 0.58 |
| 5* | HDPE | 1% CBA | 0.06 | 150 | 50 | 3:1 | 0.83 |
| 6* | HDPE | 1% CBA | 0.08 | 100 | 25 | 4:1 | 0.81 |
| 7 | HDPE | None | 0 | | | — | 0.96 |
| 8* | HDPE | 0.5% CBA | 0.075 | 175 | 50 | 3.5:1 | 0.84 |
| 9* | HDPE | 0.5% CBA | 0.075 | 150 | 50 | 3:1 | 0.86 |
| 10 | HDPE | None | 0 | | | — | 0.96 |
| 11* | PP | 0.75% CBA | 0.065 | 170 | 50 | 3.4:1 | 0.86 |
| 12 | PP | None | 0 | | | — | 0.92 |

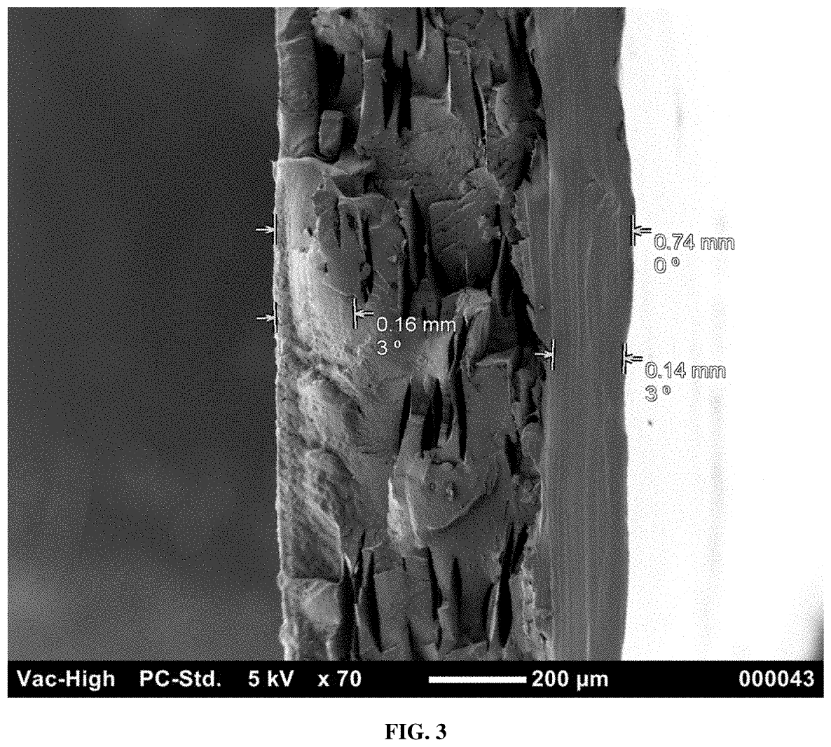

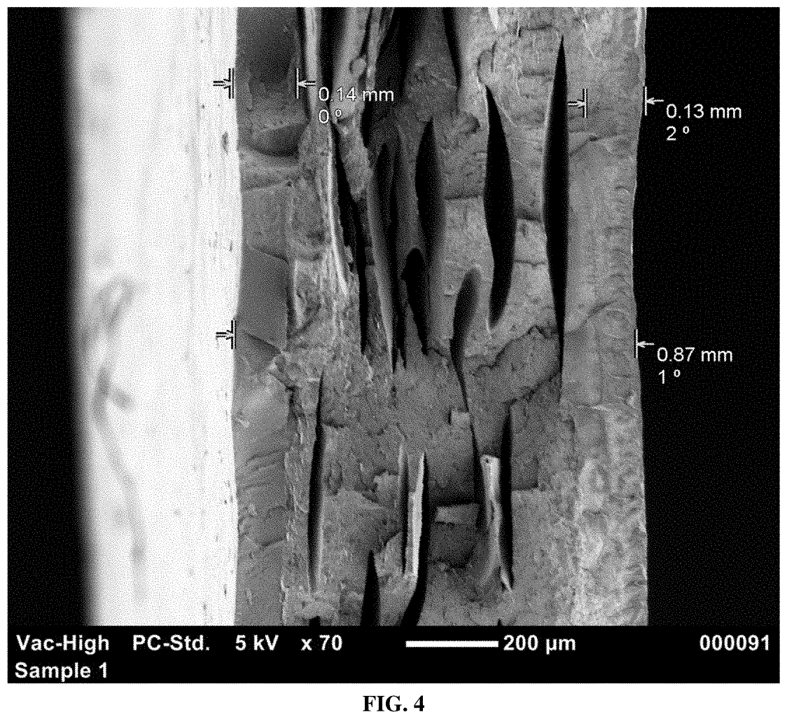

Table 1 further reports the average cell dimensions along a long (X) axis and a short (Y) axis of the cells, and the resulting aspect ratio, as determined by scanning electron microscopy (SEM) analysis of the articles. As shown in FIG. 3 (showing an SEM micrograph of Sample 5, which had a multi-layered structure with a solid-foam-solid layer thickness of 0.16 mm-0.44 mm-0.14 mm), exemplary samples prepared using CBA and N₂ had relative small, less-elongated cells. As shown in FIG. 4 (showing an SEM micrograph of Sample 3, which had a solid-foam-solid layer structure of 0.14 mm-0.60 mm-0.13 mm), foamed articles prepared using talc were observed to have elongated cells, which may explain some of the physical differences between the exemplary articles described herein and the foam articles prepared using talc. In a subset of the samples analyzed by SEM, average dimensions of cells along a long (X) axis and a short (Y) axis were estimated, and average aspect ratios of the exemplary pores were computed. As demonstrated in Table 8, foamed articles prepared using CBA and N₂ had a smaller average aspect ratio and smaller average pore dimensions, relative to foamed articles produced in other ways.

Meanwhile, Table 2 summarizes the properties of the exemplary plastic articles reported in Table 1 under various failure conditions. Specifically, Table 2 includes the % Elongation under tensile testing, the drop height associated with article failure, and the failure energy associated with impact testing of a flat sheet of material cut from the exemplary article. Since mechanical properties are often thickness-dependent, the thickness of the article, estimated by SEM, is also reported.

Tensile tests were performed using a standard ASTM D638 tensile test. During the tensile test, the bottles were stretched in order to determine the displacement resulting from the applied force (in N). Table 2 presents the maximum % elongation of each article at breaking. Solid articles did not break, so the maximum measured value, of 45% elongation, is reported. In general, greater % elongation values are preferred % elongation values, although in some cases, trade-offs exist between % elongation and article strength, meaning that a “best % elongation” may be application dependent, as well as material-dependent. In some embodiments, the % elongation of exemplary plastic articles prepared using CBA and N₂, as described herein, have a higher % elongation than foamed plastic articles produced using talc—although ultimately this depended on the sample. For example, the % elongation of Samples 4-6 greatly exceeds the % elongation observed for analogous Samples 1-3 prepared using talc.

Flat sheets cut from the exemplary articles described in Table 1, above, were analyzed using a standard ASTM D5420 impact resistance test, in order to determine their failure energy (J). Generally, the failure energy of a sheet is related to its toughness. In summary, a 2 lb weight was connected to an 0.5″ (12.7 mm) hemispherical indenter, and the indenter was subsequently dropped onto a series of sites of the sample positioned over an 0.625″ (15.9 mm) ring directly below the indenter. The indentor was dropped from a sequence of progressively increasing drop-heights, until a drop-height was sufficient to crack the sample. Then, a staircase method was used to estimate an average drop-height sufficient to cause cracking. In the staircase method, a sequence of drop-tests are performed, wherein a new drop-height is determined based on the results of the previous drop test. If the previous drop-height caused cracking, the new drop-height was reduced by 1″ (25.4 mm). If the previous drop-height did not cause cracking, the new drop-height was increased by 1″. This process was iterated at least 10 times, and the drop-heights of the iterations were averaged to generate an average drop-height sufficient to cause cracking.

The average drop-height sufficient to cause cracking was used to calculate an average failure energy, based on the gravitational potential energy of the indenter at the average drop-height sufficient to cause cracking. For example, using a standard 21b weight, a specimen having an average drop-height sufficient to cause cracking of 10 inches would have a failure energy of 20 lb-in (2.3 J).

From the impact indentation, the failure energy was determined. Although the solid articles far outperformed the foamed articles, foamed articles prepared using N₂ and CBA demonstrated improved toughness, relative to other foamed articles.

Drop tests were performed using a standard ASTM D5276 drop test. During the drop test, the bottles were dropped from various heights, in order to determine the drop height (in mm) that resulted in breaking of the exemplary plastic article. Table 2 presents the drop height (m) of each article, which is generally related to the toughness of the article. Generally, a higher drop height corresponds to a tougher bottle, and is preferred. The maximum tested drop height was 1.83 m, and samples reported to have this drop height were not observed to break.

Except in the case of Sample 4, which had a markedly reduced density, compared to the other foamed articles, articles comprising both nitrogen and CBA far exceeded the performance of articles comprising talc in both drop tests and impact indenter tests. This indicates that the exemplary articles demonstrated significantly improved toughness, relative to similar articles prepared using talc additives. This improved toughness may be advantageous, in some applications. Furthermore, comparison with Table 1 indicates that these improvements in mechanical properties may be associated with reduced cell size and reduced cell elongation. Without wishing to be bound by theory, the improved toughness of these articles may arise from these changes in the cellular structure of the plastic articles.

TABLE 2
Failure properties of exemplary articles.

| | | | | | | ASTM D5420 | ASTM |
|---|---|---|---|---|---|---|---|
| | | Additive | N₂ | Thickness | % | Failure energy | D5276 Drop |
| Sample | Resin | (wt %) | (wt %) | (mm) | Elongation | (J) | height (m) |
| 1 | HDPE | 9% Talc | 0.06 | 1.10 | 18 | 0.79 | 0.81 |
| 2 | HDPE | 9% Talc | 0.06 | 0.91 | 19 | 0.59 | 0.84 |
| 3 | HDPE | 9% Talc | 0.10 | 1.05 | 14 | 0.34 | 0.30 |
| 4* | HDPE | 1% CBA | 0.10 | 0.97 | 21 | 0.34 | 0.20 |
| 5* | HDPE | 1% CBA | 0.06 | 0.95 | 27 | 1.24 | 1.57 |
| 6* | HDPE | 1% CBA | 0.08 | 0.97 | 31 | 1.08 | 1.22 |
| 7 | HDPE | None | 0 | 0.90 | 45 (max) | 6.19 | 1.83 (max) |
| 8* | HDPE | 0.5% CBA | 0.075 | 0.86 | 18 | 1.24 | 0.51 |
| 9* | HDPE | 0.5% CBA | 0.075 | 0.93 | 37 | 1.69 | 0.91 |
| 10 | HDPE | None | 0 | 0.86 | 45 (max) | 6.31 | 1.14 |
| 11* | PP | 0.75% CBA | 0.065 | 0.94 | 32 | 1.47 | 0.81 |
| 12 | PP | None | 0 | 0.88 | 45 (max) | 5.65 | 1.14 |

### Example 2

This example describes preparation of a collection of non-limiting blow molded plastic articles with large volumes, prepared using exemplary systems and methods described herein. Like Samples 1-12 in Example 1, the articles of this example (Samples 13-14) were formed into bottles with the shape shown in FIG. 2. Sample 13 had an internal volume of 1 L and Sample 14 had an internal volume of 1.6 L. Table 3 presents exemplary additives and resins of used to produce samples 13-14. The physical properties of the foam (e.g., density, X, Y, and aspect ratio) were not measured. Samples 13 and 14 were subjected to the same battery of mechanical tests described in Example 1 above. Table 3 presents the composition of the polymer used, and the results of these tests. As in Example 1, articles prepared using nitrogen (N₂) and using chemical blowing agent (CBA) and air are indicated by an asterisk (*) next to their sample number, to distinguish them from comparative examples.

TABLE 3
Failure properties of exemplary articles.

| | | | | | | ASTM D5420 | ASTM |
|---|---|---|---|---|---|---|---|
| | | Additive | N₂ | Thickness | % | Failure energy | D5276 Drop |
| Sample | Resin | (wt %) | (wt %) | (mm) | Elongation | (J) | height (m) |
| 13* | HDPE | 0.5% CBA | 0.05 | 1.05 | 45 (max) | 5.93 | 1.83 (max) |
| 14* | HDPE | 0.5% CBA | 0.05 | 1.05 | 29 | 1.28 | 1.53 |

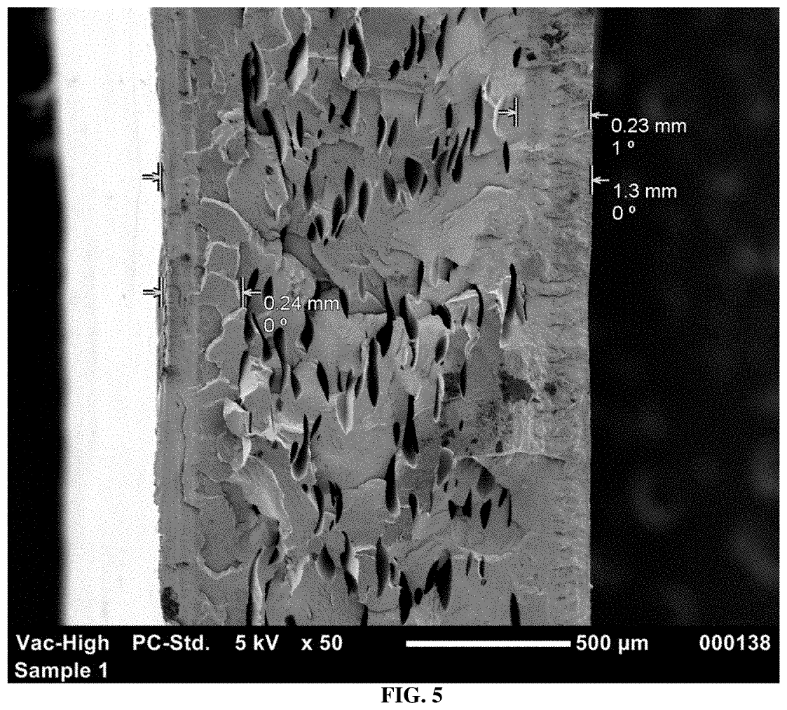

As shown in Table 3, Samples 13 and 14 had a high toughness that far exceeded the toughness of the articles of Example 1 where talc was used. Even though Sample 14 was blown to a larger size, it retained good mechancial properties. An SEM micrograph shown in FIG. 5 shows a cross-section of Sample 14, which included an 0.83 mm foam layer between an 0.23 mm solid layer and an 0.24 mm solid layer. Although an average pore size was not estimated, the pores are significantly less elongated than those of samples prepared with talc, such as the pores shown in FIG. 4 above. This example demonstrates that containers with large volume and good mechanical properties may be prepared using the methods described herein.

1. A method of blow molding a foam article comprising:
conveying a mixture comprising a first polymeric material and a chemical blowing agent in a downstream direction in a barrel of an extruder, wherein the chemical blowing agent is decomposable to form carbon dioxide and is present in an amount between 0.20 and 3.00 weight percent based on the total weight of the first polymeric material; and
introducing a physical blowing agent comprising nitrogen into the mixture through a port in the barrel, the nitrogen being present in an amount between 0.02 and 0.30 weight percent based on the total weight of the first polymeric material;
conveying a second polymeric material in a downstream direction in a barrel of an extruder; co-extruding the mixture and the second polymeric material to form a multi-layer parison in a mold cavity of a blow mold; and
recovering a multi-layered blow molded foam article from the mold cavity, the article including a foam layer comprising the first polymeric material and at least one solid layer comprising the second polymeric material.

2. The method of claim 1, wherein the first polymeric material and the second polymeric material comprise the same polymer.

3. The method of claim 1, wherein the second solid layer is on a first side of the foam layer, and wherein the article includes a second solid layer on an opposite side of the foam layer.

4. The method of claim 1, wherein the foamed layer has a thickness greater than or equal to 50% of a thickness of the article.

5. The method of claim 1, wherein the physical blowing agent comprising nitrogen blowing agent is present in an amount between 0.03 and 0.15 weight percent based on the total weight of the polymeric material.

6. The method of claim 1, wherein the chemical blowing is present in an amount between 0.3 and 1.3 weight percent based on the total weight of the polymeric material.

7. The method of claim 1, wherein the chemical blowing agent is one or more of citric acid, sodium bicarbonate, monosodium citrate, calcium carbonate and zinc stearate.

8. The method according to claim 1, wherein the chemical blowing agent is added to the mixture as a separate ingredient.

9. The method of claim 1, wherein the foam article comprises a semi-crystalline polymer.

10. The method of claim 1, wherein the polymeric material comprises polyethylene and/or polypropylene.

11. The method of claim 1, wherein the foam article has a failure energy of at least 0.9 J per millimeter of thickness, as measured by a standard ASTM D5420 impact resistance test.

12. The method of claim 1, wherein the foam article has a wall thickness of less than 3 mm.

13. The method of claim 1, wherein the foam article has a void volume percentage of between 2% and 40%.

14. The method of claim 1, wherein the foam article has an average minimum cell dimension of less than 100 microns.

15. The method of claim 1, wherein the foam article has an average maximum cell dimension of less than 250 microns.

16. The method of claim 1, wherein cells of the foam article have an average aspect ratio of less than or equal to 5.

17. The method of claim 1, wherein the mixture is a single-phase solution comprising the polymeric material, nitrogen, and carbon dioxide prior to injection into the mold.

18. The method of claim 1, wherein the mixture does not comprise talc.

19. The method of claim 1, wherein the blow molded article is a container with an interior volume of greater than or equal to 0.5 L.

20. The method of claim 1, wherein the blow molded article comprises a foamed layer.

21. The method of claim 20, wherein the foamed layer has a thickness greater than or equal to 50% of a thickness of the article.

22. A blow molded foam article comprising a polymeric material, the article having cells with an average aspect ratio of less than or equal to 5, a thickness of less than 2 mm, a void volume percentage of between 2 and 40%, and failure energy of at least 0.9 J per millimeter of thickness, as measured by a standard ASTM D5420 impact resistance test.

23-27. (canceled)
